(19) United States
(12) Patent Application Publication
(10) Pub. No.: US 2011/0258569 A1
(43) Pub. Date: Oct. 20, 2011

(54) DISPLAY OF FILTERED DATA VIA FREQUENCY DISTRIBUTION

(75) Inventors: Jeffrey Weir, Seattle, WA (US); Orry Soegiono, Seattle, WA (US); Alex Weinstein, Seattle, WA (US)

(73) Assignee: MICROSOFT CORPORATION, Redmond, WA (US)

(21) Appl. No.: 12/763,932

(22) Filed: Apr. 20, 2010

(51) Int. Cl. G06F 3/048

(52) U.S. Cl. 715/771

(57) ABSTRACT

Embodiments related to the display of filtered data via a frequency distribution are disclosed. One embodiment provides filtering a collection based on a category to create a subset of the collection, wherein the subset comprises one or more items each having metadata corresponding to the category and a value associated with the metadata. The method further includes ranking the subset based on the values associated with the metadata, determining lower and upper endpoints of the values, determining a range of the subset, and sending to a display a user interface object comprising a frequency distribution and a slider object indicating a selected portion of the range. The method further includes sending to a results portion of the display one or more items of the subset having values associated with the metadata which fall within the selected portion of the range.

### BACKGROUND

Sorting through large collections of data, such as catalogs of images, music data, video data, etc., can be tedious and time-consuming, as such large collections of data may be difficult to organize and analyze. Various filtering tools may allow a user to more easily locate and view subsets of data of interest within a collection. However, if a subset of data obtained through a filtered search is larger than a user would like, and/or comprises data with a relatively large range of search parameter values, it may be difficult for a user to narrow the subset of results displayed without performing additional filtered searches. As a result, attempting to understand and form conclusions from the subset of data may pose challenges.

### SUMMARY

Various embodiments are disclosed herein that relate to the display of filtered data via a frequency distribution. For example, one disclosed embodiment provides filtering the collection based on a category to create a subset of the collection, wherein the subset comprises one or more items each having metadata corresponding to the category and a value associated with the metadata. The method further includes ranking the subset based on the values associated with the metadata, determining a lower endpoint and an upper endpoint of the values associated with the metadata, and determining a range of the subset, wherein the range is defined between the lower endpoint and the upper endpoint. The method further includes sending to a display a user interface object comprising a frequency distribution of the subset for the range, wherein the user interface object further comprises a range indication user interface object indicating a selected portion of the range. The method further includes sending to a results portion of the display one or more items of the subset having values associated with the metadata which fall within the selected portion of the range.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an example embodiment of a use environment for filtering a collection of items in accordance with an embodiment of the present disclosure.

FIG. 2 shows a flow diagram of an embodiment of a method of filtering a collection comprising a plurality of items.

FIGS. 3-9 show schematic depictions of various example embodiments of user interfaces comprising frequency distribution displays, and also illustrate examples of user interactions therewith.

### DETAILED DESCRIPTION

As described above, difficulties may be encountered in viewing and filtering large collections of data in a manner that allows a user to easily draw conclusions from the data or see patterns within the data. For example, in a collection of retail shopping data, it may be difficult for a user to filter the collection to a desired arbitrary range of a specific category (e.g., price: $10-$15), to change the desired arbitrary range while keeping the size of the range constant (e.g., price: $11-$16), and/or to easily understand the distribution of items within the specific category (e.g., there are many items priced under $20 and many items above $100). It may also be difficult to achieve these tasks using non-numeric ranges (e.g., size: on a scale of XS to XXL, show M to XL).

Accordingly, various embodiments are disclosed herein that relate to the filtering and presentation of data in a collection via display of a frequency distribution based upon metadata associated with each item in the collection, and also to the display of selected portions of data represented by the frequency distribution via user interface controls associated with the frequency distribution. The disclosed user interface control embodiments allow a portion of the range of the frequency distribution to be selected, such that a results portion of the display displays items corresponding to the selected portion of the range, while the frequency distribution continues to display the entire range. As such, users can not only easily filter vast amounts of data, but they can do so in a visual manner which may increase a user's ability to analyze/identify patterns within the data and form conclusions from the data.

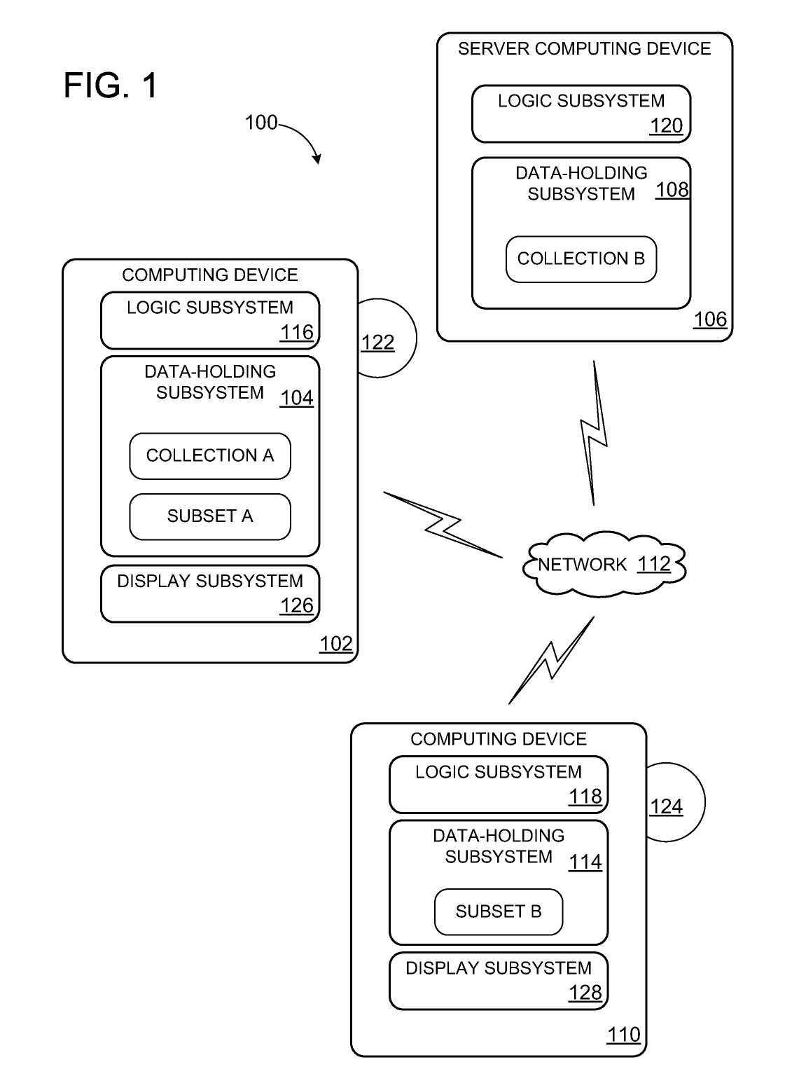

FIG. 1 shows an embodiment of an example use environment 100 for filtering a collection of items in accordance with the present disclosure. Such items may be any suitable type of item comprising associated metadata. As an example, a collection of items may be a collection of webpages wherein each webpage has metadata corresponding to properties of the page such as a title, subject, content, etc. As another example, a collection of items may be a collection of electronic issues of a magazine, wherein each issue has metadata associated with the issue such as a date, a topic, etc. As yet another example, a collection of items may be a collection of dog breed information, wherein each item corresponds to a particular dog breed and thus has metadata associated with the item such as a breed name, physical traits, behavioral traits, size, weight, etc. It can be appreciated that these examples are presented for the purpose of example, and are not intended to be limiting in any manner.

Continuing with FIG. 1, a collection of items may be stored locally on a computing device or may be stored remotely on a server computing device. For example, computing device 102 includes a collection, namely collection A, stored locally within a data-holding subsystem 104 of computing device 102. Computing device 102 may be configured to filter collection A to create a subset of collection A, depicted as subset A, as described in more detail hereafter. Likewise, server computing device 106 includes a collection, namely collection B, stored on a data-holding subsystem 108 of server 106. Collection B may be accessed by another computing device, such as computing device 102 and/or computing device 110, via a network such as network 112. As depicted, computing device 110 filters collection B to create a subset of collection B, depicted as subset B, as described in more detail below. It will be understood that collections also may be stored in peer-to-peer networks, such that computing device 110 may search and filter collection A on computing device 102. It will further be understood that these embodiments are described for the purpose of example, and are not intended to be limiting in any manner.

Computing devices 102 and 110 each comprise a logic subsystem, shown at 116 and 118, respectively, configured to execute instructions stored in data-holding subsystems 104 and 114, respectively, to perform the embodiments related to filtering and display of collections of items described herein. Server computing device 106 also includes a logic subsystem 120 configured to execute instructions stored in data-holding subsystem 108 to search collection B and provide search results to a requesting client computing device. Computing device 102, computing device 110 and server computing device 106 may optionally include other components not shown in FIG. 1.

A logic subsystem (e.g., logic subsystem 116, logic subsystem 118, logic subsystem 120) may include one or more physical devices configured to execute one or more instructions. For example, a logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

A data-holding subsystem (e.g., data-holding subsystem 104, data-holding subsystem 114, data-holding subsystem 108) may include one or more physical devices, which may be non-transitory, and which are configured to hold data and/or instructions executable by the logic subsystem to implement the herein described methods and processes. When such methods and processes are implemented, the state of the data-holding subsystem may be transformed (e.g., to hold different data). The data-holding subsystem may include removable computer-readable media and/or built-in computer-readable media. The data-holding subsystem may include optical memory devices, semiconductor memory devices, and/or magnetic memory devices, among others. The data-holding subsystem may include devices with one or more of the following characteristics: volatile, nonvolatile, dynamic, static, read/write, read-only, random access, sequential access, location addressable, file addressable, and content addressable. In some embodiments, a logic subsystem and data-holding subsystem of a same computing device may be integrated into one or more common devices, such as an application specific integrated circuit or a system on a chip.

FIG. 1 also illustrates computer-readable removable media 122 and 124 which may be used to store and/or transfer data and/or instructions executable by computing devices 102 and 110, respectively, to implement the herein described methods and processes.

Computing device 102 and computing device 110 also each includes a display subsystem, shown at 126 and 128, respectively. With regard to computing device 102, display subsystem 126 may be used to present a visual representation of data held by data-holding subsystem 104. Likewise, with regard to computing device 110, display subsystem 128 may be used to present a visual representation of data held by data-holding subsystem 114. As the herein described methods and processes change the data held by the data-holding subsystem, and thus transform the state of the data-holding subsystem, the state of display subsystem may likewise be transformed to visually represent changes in the underlying data. The display subsystem may include one or more display devices utilizing virtually any type of technology. Such a display device may be combined with a logic subsystem and/or a data-holding subsystem in a shared enclosure, or such display devices may be peripheral display devices. A display subsystem may be configured to display user interface objects, such as user interface objects comprising frequency distributions. Further, a display subsystem may also be configured to display items in a results portion of the display, described in more detail below.

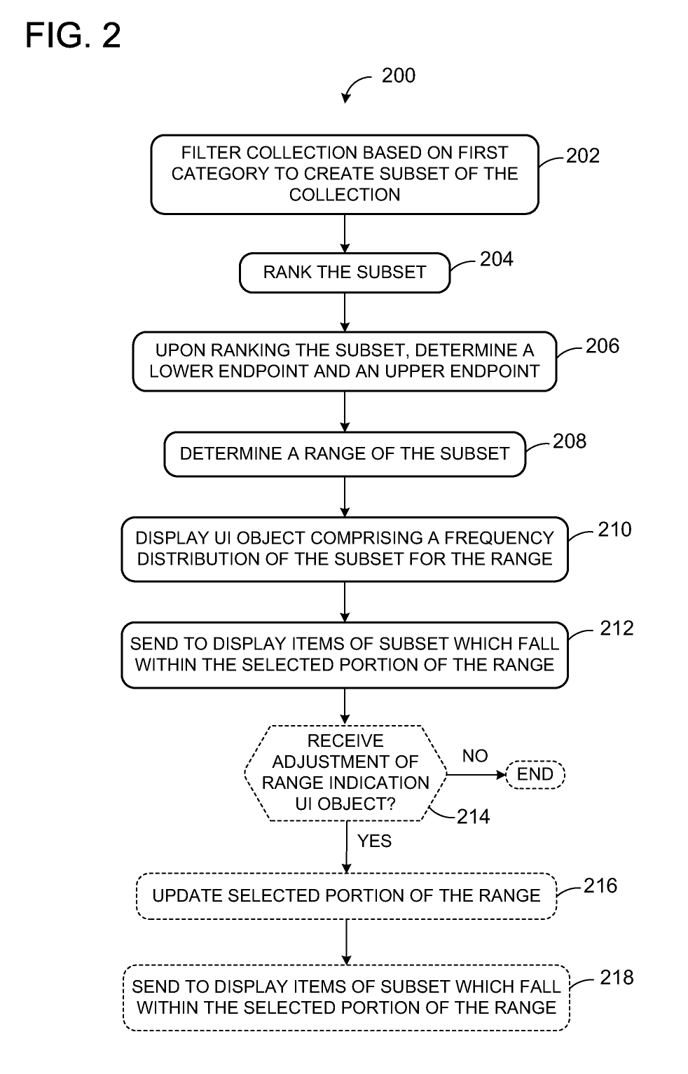

FIG. 2 illustrates an embodiment of a method 200 of filtering a collection comprising a plurality of items. It will be understood that method 200 is performed via instructions executed by a computing system. The collection of items may be stored on the same computing device performing method 200, or may be stored on another network-accessible computing device, such as that of a network-accessible server or peer.

Each item of the collection comprises associated metadata. Such metadata may correspond to various categories and may have various associated values. As such, the metadata can be used to filter the collection, rank items, etc.

At 202, method 200 includes filtering the collection based on a category to create a subset of the collection. The category may be any suitable category to which the items of the collection have corresponding metadata. For example, the collection of items may be a collection of items for sale, and the category is a “price” category. As another example, the collection of items may be a collection of clothing offered by an online retailer, and the category is a “size” category. As yet another example, the collection of items may be a collection of population data, where each item corresponds to a particular person. In such a case, the category may be an “age” category. It can be appreciated that these examples are nonlimiting, and that method 200 may be utilized with any other suitable collection of items.

Filtering the collection based on the category creates a subset of the collection, wherein the subset of the collection comprises one or more items each having metadata corresponding to the category and a value associated with the metadata. As such, the metadata corresponding to the category may be numerical or non-numerical. In the aforementioned examples, price metadata and age metadata may be numerical (e.g., $10, 39, etc.), whereas size metadata may be non-numerical (e.g., XS, L, etc.).

At 204, method 200 includes ranking the subset based on the values associated with the metadata. In the case that the metadata corresponding to the category is numeric, in some embodiments the numeric metadata may itself be the value. In other words, price metadata may be ranked from low values to high values by ranking the prices of the items from low to high. As another example, age metadata may be ranked from low values to high values by ranking the ages from low to high. However, in the case that the metadata is non-numeric, metadata values may be ranked in another manner. For example, each metadata value may have an assigned numerical value, allowing the subset to be ranked. For example, size metadata of XS, S, M, L and XL may have values of 1, 2, 3, 4 and 5, respectively, which establishes a hierarchy within the data, such that size XS is followed by size S, which is followed by size M, etc. Alternatively, the non-numeric metadata may instead be ranked by listing the text values in order in the collection header, allowing the subset to be ranked without having specific numeric mappings.

At 206, method 200 includes, upon ranking the subset, determining a lower endpoint and an upper endpoint of the values associated with the metadata. As an example, a lower endpoint may be determined by a smallest value of the values associated with the metadata, whereas the upper endpoint may be determined by a largest value. For example, in the case of the aforementioned example for size metadata, the lower endpoint may be 1 which corresponds to XS, while the upper endpoint may be 5 which corresponds to XL.

At 208, method 200 includes determining a range of the subset. The range may be defined between the lower endpoint and the upper endpoint. For example, in the case of the size metadata discussed above, the range may be defined between the lower endpoint 1 and the upper endpoint 5. It can be appreciated that the range may be represented as numeric or non-numeric. For example, in the aforementioned example, the range could alternatively be represented by the metadata associated with the endpoints, such that the range is defined from XS to XL.

At 210, method 200 includes sending to a display a user interface object comprising a frequency distribution of the subset for the range. The frequency distribution displays the distribution of items relevant to a specific category, which in this example, is the category with which the collection was filtered at 202. The frequency distribution may be represented in any suitable visual representation. In one example, the items of the subset could be grouped into various “buckets” of the range, and displayed so as to indicate the frequency of items (e.g., number of observations) per bucket. For example, the frequency distribution may comprise a histogram, wherein a vertical axis corresponds to a frequency of items of the subset, and a horizontal axis corresponds to various buckets within which the items are grouped. As such, the frequency of items per bucket can be represented as a bar for that bucket. In other words, in some embodiments, the frequency distribution may comprise a histogram visually presented as a bar graph. In other embodiments, the frequency distribution may be visually presented in any other suitable manner. Further yet, the filtering need not be one-dimensional. For example, the frequency distribution may include a bubble chart with two-dimensional selection to display and filter two-dimensional data.

As an example, referring to the aforementioned size metadata example, there may be one bucket per size. Thus, the horizontal axis may be labeled with five buckets, namely, XS, S, M, L and XL. The bar corresponding to each bucket illustrates the number of items of the subset having a size corresponding to that bucket. As such, a user can understand not just how many of each size are in the collection (e.g., the number of size M shirts) but also relative information about the subset (e.g., there are many more size L shirts than size M shirts).

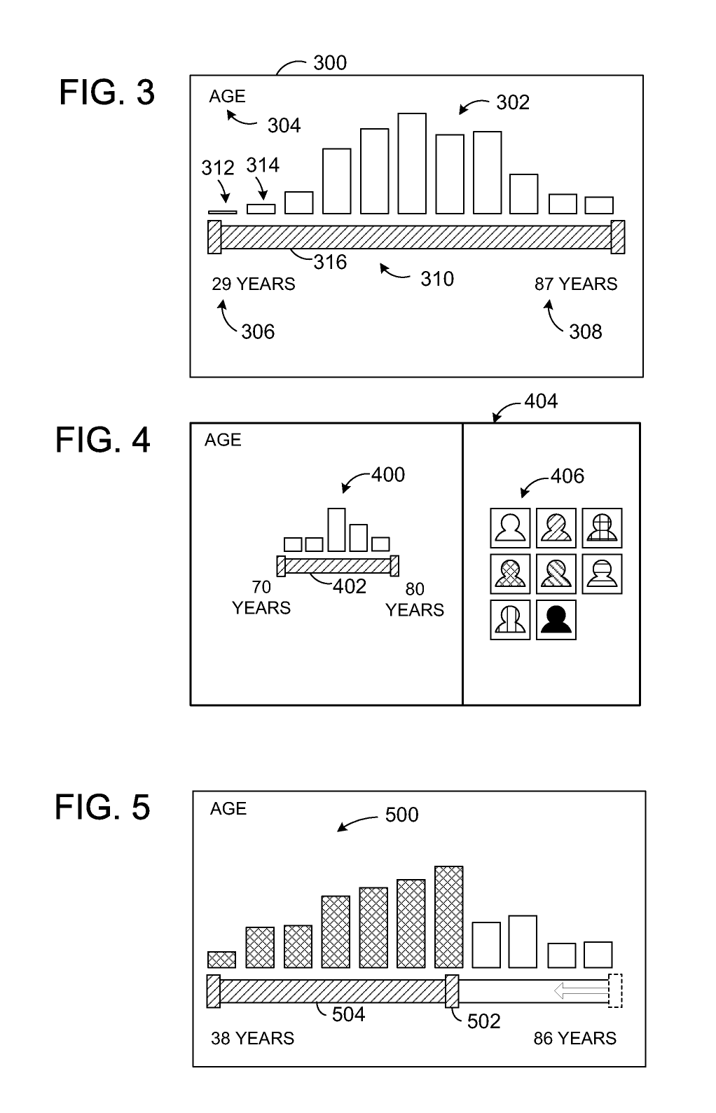

As another example, FIG. 3 shows an embodiment of a user interface object 300 displayed on a display. User interface object 300 includes a frequency distribution 302 for a subset of items having metadata corresponding to an “age” category 304. In this example, the values range from a lower endpoint of 29 years to an upper endpoint of 87 years, as indicated at 306 and 308, respectively. As such, the frequency distribution is displayed for the range 310 of the items of the subset defined between 29 years and 87 years. Each bar of the distribution then represents a span of ages. As an example, each bar may represent six years, such that the first bar 312 corresponds to ages 29-34, the second bar 314 corresponds to ages 35-40, etc. Further, the height of each bar indicates the frequency of items in the subset associated with the span of years to which the bar corresponds. In the case of the depicted example, there are more items in the subset of the collection associated with ages of the middle of range 310, than to ages at each end of range 310, as indicated by the larger height of the bars in the middle region of range 310. It can be appreciated that although a linear scale is depicted for the distribution of FIG. 3, other scales may be used, such as logarithmic scales, exponential scales, etc.

The user interface object may further comprise a user interface object indicating a selected portion of the range. In the case of the example depicted in FIG. 3, a range indication bar 316 indicates the selected portion of the range to be the entire range between 29 years and 87 years. The range indication user interface object is adjustable, in that it may be adjusted in response to receiving an adjustment input, described in more detail hereafter with reference to 214. It will be understood that the term “range indication user interface object” represents a graphical user interface control element movable along a displayed path. The path may be curved, straight, or have any other suitable shape, and the range indication user interface object may move in discrete steps or in a continuous manner. Further, a user may move the range indication user interface object by interacting directly with the range indication user interface object via a cursor, touch-sensitive interface, etc., or in an indirect manner via other controls. In some embodiments, multiple range indication user interface objects may be utilized with the range, allowing a user to select two or more non-intersecting subsets of the range.

At 212, method 200 includes sending to a results portion of the display one or more items of the subset having values associated with the metadata which fall within the selected portion of the range. In other words, the selected portion of the range dictates which items of the subset are displayed in a results portion of the displayed user interface, which may occupy a different space on a display as the frequency distribution. Items may be displayed in the results portion in any suitable manner. For example, each item may be displayed as an image or icon representing that item. As an example, in the case of a collection of electronic magazines, each item (e.g., magazine) may be displayed in the results portion of the display as an image visually depicting the cover of that magazine.

FIG. 4 illustrates an embodiment of a results portion 404 of a user interface with items displayed for a frequency distribution 400 with a range 402 of 70-80 years. Results portion 404 is depicted as displaying items 406 which have ages corresponding to the selected portion of the range 402. In this example, each item is a person having age metadata corresponding to the selected portion of the range, namely the range of 70-80 years (which is the entire range in this example).

In some embodiments, the addition or removal of items to the results portion of the user interface may be displayed via the animated movement of items into or out of the results portion. As an example, if the items were not already displayed on the results portion of the display, then an animation may be displayed bringing these items into view on the results portion of the display. As another example, if the items are already displayed on the results portion, then items of the subset having values associated with the metadata which fall outside of the selected portion of the range (i.e., non-selected items) may be removed from the results portion via an animation, such that the selected items remain displayed. Further, in some embodiments, as non-selected items are removed from the display portion, the selected items displayed on the results portion of the display may be enlarged in display size, rearranged on the display, etc.

As briefly introduced above, the range indication user interface object may be adjusted to change the selected portion of the range. Accordingly, at 214, method 200 may optionally include determining if an adjustment of the range indication user interface object has been received. As an example, the depicted range indication user interface object comprises a first adjustable left-hand range indication object and a second adjustable right-hand side range indication objects that together designate a selected portion of the range. Adjustment of the depicted range indication objects (e.g., via drag and drop placement) may then adjust the selected portion of the range. FIG. 5 shows an example frequency distribution 500, wherein a right-hand side range indication object 502 has been adjusted to indicate the selected portion of the range 504. As depicted, the range indication object may be in the form of a “slider” user interface object. However, it can be appreciated that this is just one of many possible user interface objects that may be used to indicate the range.

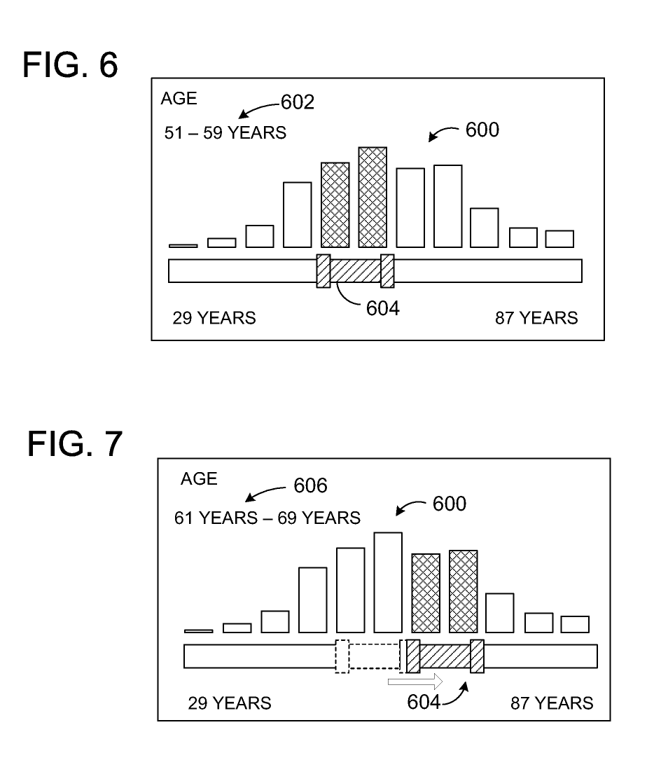

As another example, the adjustment may include a selection of a predetermined range corresponding to the metadata. For example, the user interface object may list various user-selectable “preset” options which correspond to sub-groups within the selected category. For example, in the case of age metadata, preset options may include “young,” “middle-aged” and “elderly.” FIG. 6 shows an example frequency distribution 600, wherein a preset range 602 has been selected, for example via a user input, which selects a portion of the range 604, namely the portion of the distribution that corresponds to ages 51-59.

As another example, each side range indication object may have a corresponding value field, and a user may change the value in the value field to adjust the position of the side range indication object. For example, a user may be able to click on the field and input a new value for the field via an input device such as a keyboard. As yet another example, the selected portion of the range may be repositioned, such that although the positions of the side range indication objects have changed (e.g., from 51-59 years to 61-69 years), the selected range maintains the same span of values as the initial selected range (e.g., nine years) FIG. 7 shows the frequency distribution 600 of FIG. 6, wherein the selected portion of the range 604 has been moved to the right ten years. As such, the selected portion of the range 604 corresponds to ages 61-69 yet still spans nine years. As such, a descriptor may update to display the updated selected portion of the range, as indicated at 606.

It can be appreciated that the range indication user interface object may be adjusted in virtually any manner so as to indicate a selected portion of the range. For example, a user may select a bar of the frequency distribution (e.g., via a mouse click) to set the selected portion of the range to that bar. As another example, a user may select another bar (e.g., via Shift+mouse click) to define a selected portion of the range. As yet another example, a user may select the range (e.g., via a click and horizontal drag on a histogram) to define a selected portion of the range.

Returning to FIG. 2, if an adjustment of the range indication user interface object is received, method 200 proceeds to 216 wherein the selected portion of the range is updated based on the adjustment. This may include updating a representation of the range as stored in the data-holding subsystem and/or updating a visual presentation of the range displayed for the frequency distribution of the user interface object. Updating display of the selected portion of the range may be done in any suitable manner. In some embodiments, an animation may be displayed so as to visually present a transition from the previously selected portion of the range to the updated portion.

At 218, method 200 includes sending to a results portion of the display one or more items of the subset having metadata corresponding to the updated selected range. In this way, changing the selected portion of the range changes the items shown in the results portion of the display. The results portion of the display may be updated in any suitable manner. For example, in some embodiments, upon receiving an adjustment of the range indication user interface object, newly selected items may be displayed via an animation so as to appear in the results portion and non-selected items may be removed from display via an animation.

The results portion of the display may be a portion of the display distinct from that the portion of the display displaying the frequency distribution, and the two therefore may be displayed together on the display. Further, the selected portion of the range may be visually distinguished in the frequency distribution from the unselected portion(s) of the range. In this manner, a user can easily tell that the selected items being displayed in the results portion correspond to the selected portion of the range visually indicated on the frequency distribution.

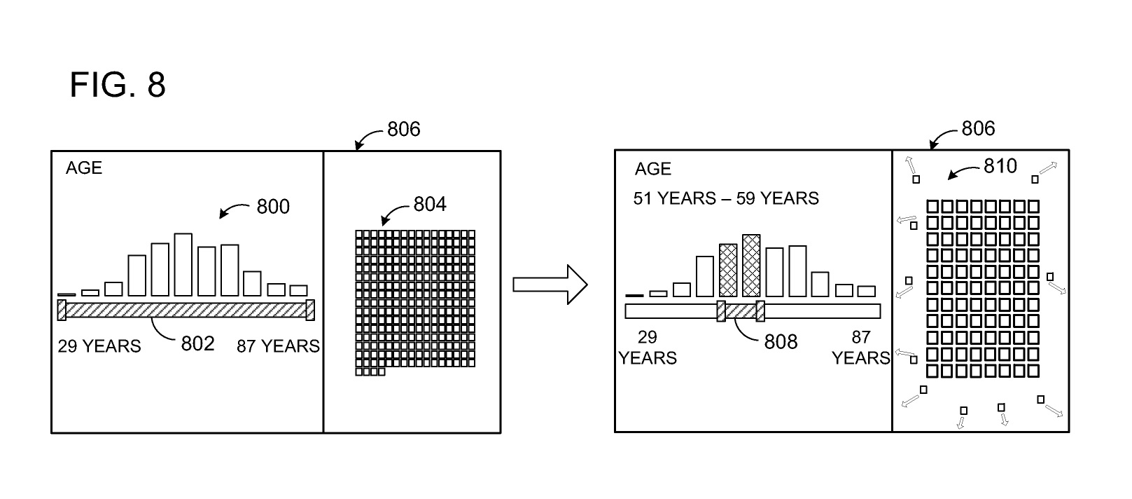

As an example, FIG. 8 shows an example of a frequency distribution 800. As indicated at 802, the entire portion of the range is selected. As such, all items of the subset are the selected items 804 displayed in results portion 806 of the display. Upon receiving an adjustment to the range indication user interface object, the selected portion of the range is updated as indicated at 808. Accordingly, results portion 806 of the display updates based on the newly selected portion of the range. For example, as shown at 810, the computing device may be configured to display an animation of non-selected items leaving the results portion 806, and selected items appearing on the results portion 806. Further, the selected items may be enlarged in size and/or may be rearranged, for example via an animation, as more display space becomes available in the results portion 806.

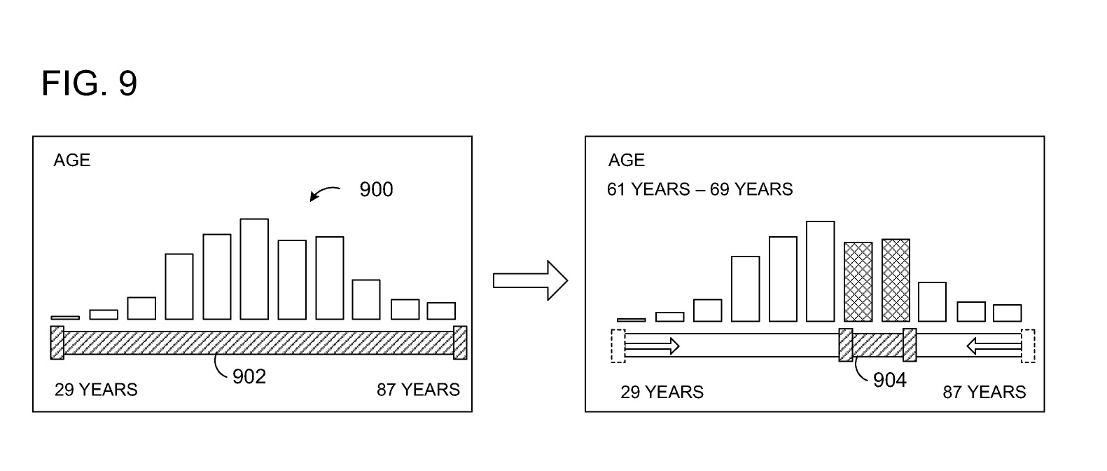

As described above, various animations may be utilized to display the items of the subset of the collection in the results portion. Additionally or alternatively, animations may be utilized with respect to the range indication user interface. As an example, upon selecting a preset selected portion of the range, the endpoints of the selected range may automatically adjust to their new locations. For example, FIG. 9 illustrates a frequency distribution 900. Upon selection of a preset selected portion of “middle aged” (e.g., corresponding to 61-69 years), the endpoints of the selected range 902 may animate to new positions corresponding to the updated selected portion 904. It can be appreciated that this example is nonlimiting, and is just one of many possible animations which may be visually presented on the display.

It can be appreciated that in some embodiments, the frequency distribution may update responsive to time-sensitive values associated with the metadata of the items of the collection. As an example, the frequency distribution may adjust in response to real-time or time-delayed changes in collection information without the occurrence of filtering by a different facet category. For example, a collection may include 500 publicly traded stocks. The collection may be filtered on a stock price category to show all stocks between $20 and $30. However, the stock prices may be changing over time (e.g., every second, every minute, or any other time delta) to reflect the price of stocks on the market. In such a case, the frequency distribution and filterable range may update accordingly, even though the stock price filter itself remains the same (namely, to filter the collection to show all stocks having stock prices between $20 and $30).

The display of filtered data via a frequency distribution as described herein thus provides for the ability to view any data that may be ranked by value (whether the data is numerical or non-numerical) in a form that gives information into the distribution of values within the data. Further, the depicted embodiments of user interface controls allow a user to easily view specific items within a selected portion of data within the distribution. Further, if the selectable range is modified by other filters, the distribution and range endpoints can adjust accordingly. As such, collection filtering and frequency distribution display provides for communicating the selected range in human-understandable terms and offers author-defined preset ranges that might be interesting to the user.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of filtering a collection comprising a plurality of items, each item comprising associated metadata, the method comprising:
filtering the collection based on a category to create a subset of the collection, the subset comprising one or more items each having metadata corresponding to the category and a value associated with the metadata;
ranking the subset based on the values associated with the metadata;
upon ranking the subset, determining a lower endpoint and an upper endpoint of the values associated with the metadata;
determining a range of the subset, the range being defined between the lower endpoint and the upper endpoint;
sending to a display a user interface object comprising a frequency distribution of the subset for the range, the user interface object further comprising a range indication user interface object indicating a selected portion of the range; and
sending to a results portion of the display one or more items of the subset having values associated with the metadata which fall within the selected portion of the range.

2. The method of claim 1, wherein sending one or more items of the subset includes sending an animation of non-selected items being removed from the results portion of the display, the non-selected items comprising one or more items of the subset having values associated with the metadata which fall outside of the selected portion of the range.

3. The method of claim 2, wherein sending one or more items of the subset includes sending an animation of selected items appearing on the results portion, the selected items comprising the one or more items of the subset having values associated with the metadata which fall within the selected portion of the range.

4. The method of claim 1, wherein the range is numeric.

5. The method of claim 1, wherein the range is non-numeric.

6. The method of claim 5, wherein, for each item, the value associated with the metadata is non-numeric and wherein the value has a numeric mapping utilized for ranking the subset.

7. The method of claim 5, wherein, for each item, the value associated with the metadata is non-numeric, and wherein the value is listed in order in a collection header utilized for ranking the subset.

8. The method of claim 1, further comprising receiving an adjustment of the range indication user interface object selecting the selected portion of the range.

9. The method of claim 8, wherein the adjustment includes a selection of a value for one or more of a left-hand side range indication user interface object and a right-hand side range indication user interface object defining the selected portion of the range on the range indication user interface object.

10. The method of claim 8, wherein the adjustment includes a repositioning of the selected portion of the range along the range indication user interface object while maintaining a span of values of the range.

11. The method of claim 8, wherein the adjustment includes a selection of a predetermined range corresponding to the metadata.

12. The method of claim 1, wherein, for each item, the value associated with the metadata is time-sensitive.

13. The method of claim 1, further comprising receiving an adjustment of the range indication user interface object selecting the selected portion of the range, and in response, updating the results portion of the display to display an animation of non-selected items being removed from the results portion and an animation of selected items appearing on the results portion, the non-selected items comprising items of the subset having values associated with the metadata which fall outside of the selected portion of the range and the selected items comprising items of the subset having values associated with the metadata which fall within the selected portion of the range.

14. A computer-readable storage medium comprising instructions stored thereon that are executable by a computing device to:
filter the collection based on a category to create a subset of the collection, the subset comprising one or more items each comprising metadata corresponding to the category and a value associated with the metadata, and the subset being ranked based on the values associated with the metadata;
send to a display a user interface object comprising a frequency distribution of the subset for a range of the subset, the range being defined between a lower endpoint and an upper endpoint of ranked values associated with the metadata, and the user interface object further comprising a slider user interface object indicating a selected portion of the range;
send to a results portion of the display one or more items of the subset having values associated with the metadata which fall within the selected portion of the range;
receive an adjustment of the slider user interface object updating the selected portion of the range; and
in response, send to the results portion of the display one or more items of the subset having values associated with the metadata which fall within the selected portion of the range.

15. The computer-readable storage medium of claim 14, wherein the instructions are configured to send the one or more items of the updated subset by sending an animation of non-selected items being removed from the results portion and selected items appearing on the results portion, the non-selected items comprising items of the subset having values associated with the metadata which fall outside of the selected portion of the range, and the selected items comprising items of the subset having values associated with the metadata which fall within the selected portion of the range.

16. The computer-readable storage medium of claim 14, wherein the range is one of numeric and non-numeric.

17. The computer-readable storage medium of claim 14, wherein the adjustment comprises one of a selection of a value for one or more of a first side slider user interface object and a second side slider user interface object defining the selected portion of the range on the slider user interface object, a repositioning of the selected portion of the range along the slider user interface object while maintaining a span of values of the range, a selection of a predetermined range corresponding to the metadata, and a selection of a frequency bar of the frequency distribution.

18. A computing device, comprising:
a display configured to display a user interface;
a logic subsystem configured to execute instructions and to access a database comprising a collection comprising a plurality of items, each item having metadata; and
a data-holding subsystem holding instructions executable by the logic subsystem to:
filter the collection based on a category to create a subset of the collection, the subset comprising one or more items each comprising associated metadata corresponding to the category and a value associated with the metadata corresponding to the category, and the subset being ranked based on the values associated with the metadata;
display, on the display, a user interface object comprising a frequency distribution of the subset for a range of the subset, the range being defined between a lower endpoint and an upper endpoint of ranked values associated with the metadata corresponding to the category, and the user interface object further comprising a slider user interface object indicating a selected portion of the range;
display, on a results portion of the display, one or more items of the subset having values associated with the metadata corresponding to the category which fall within the selected portion of the range;
receive an adjustment of the slider user interface object updating the selected portion of the range; and
in response, display, on the results portion of the display, one or more items of the subset having values associated with the metadata which fall within the selected portion of the range.

19. The computing device of claim 18, wherein the range is one of numeric and non-numeric.

20. The computing device of claim 18, wherein the adjustment comprises one of a selection of a value for one or more of a first side slider user interface object and a second side slider user interface object defining the selected portion of the range on the slider user interface object, a repositioning of the selected portion of the range along the slider user interface object while maintaining a span of values of the range, a selection of a predetermined range corresponding to the metadata, and a selection of a frequency bar of the frequency distribution.
